(19) United States
(12) Patent Application Publication
(10) Pub. No.: US 2021/0016310 A1
(43) Pub. Date: Jan. 21, 2021

(54) Turf Printing and Removal Using Foaming Carrier

(71) Applicants: Pete J. Davis, Pleasanton, CA (US); David Sickert, Pleasanton, CA (US)

(72) Inventors: Pete J. Davis, Pleasanton, CA (US); David Sickert, Pleasanton, CA (US)

(21) Appl. No.: 16/933,424

(22) Filed: Jul. 20, 2020

Related U.S. Application Data
(60) Provisional application No. 62/875,721, filed on Jul. 18, 2019.

(51) Int. Cl. B05B 13/00; C09D 5/02; C09D 7/20; C09D 7/45; B05D 1/02; B05B 7/00

(52) U.S. Cl. CPC B05B 13/005; C09D 5/021; B05B 7/0018; C09D 7/45; B05D 1/02; C09D 7/20

(57) ABSTRACT

A system and composition for imprinting and removing high resolution images onto natural or artificial lawns and fields, covered areas such as sports fields, and landscapes, using a foaming carrier composition which enhances the functional performance of liquids containing special active agents to accomplish specific tasks such as marking and painting. The foaming carrier composition can be a solution of one or more active agents for painting, cleaning, lubricating, fertilizing, and effervescing various surfaces including athletic fields.

### CROSS-REFERENCE TO RELATED APPLICATIONS

The present invention claims priority to U.S. Provisional Patent Application No. 62/875,721, filed Jul. 18, 2019, which is incorporated herein by reference in its entirety.

### FIELD OF THE DISCLOSURE

The invention relates to a system and composition for imprinting and removing high resolution images onto natural or artificial lawns and fields, covered areas such as sports fields, and landscapes, using a foaming carrier composition which enhances the functional performance of liquids containing special active agents to accomplish specific tasks such as marking and painting. The foaming carrier composition can be a solution of one or more active agents for painting, cleaning, lubricating, fertilizing, and effervescing various surfaces including athletic fields.

### BACKGROUND OF THE DISCLOSURE

Sports turf management involves the establishment and maintenance of athletic fields for the purpose of providing aesthetically pleasing, wear resistant, and safe surfaces for competition. There is continued pressure to maintain superior aesthetic quality under intense use regimes of multiple sports clubs, for the purposes of promoting a high quality television and video product, and maintaining safety at the recreational levels.

Multi-use facilities that host a variety of sporting events must continually confront the problem of residual marking paint used to determine boundaries. Present systems and compositions for removal of paint from turf often are ineffective and hence do not thoroughly remove the previously applied paint. The painting and marking compositions and the compositions for their removal may significantly distort the visual appearance of the turf, discolor the turf, build up in underlying soils, synthetic turf, backing and infill, or cause the affected areas of turf to be killed. This is of particular concern to sports clubs and associations that share facilities with other sports clubs for logistical and economic reasons. When sporting events are televised, residual marking paint from other sporting events detracts from the quality of the product. In addition, all levels of sports (from town and scholastic to collegiate and professional) are faced with sharing facilities that require a variety of marking patterns.

It is customary to provide certain markings with chalk, lime, or paint of the various portions of the field on which the game is played. It is also common for teams to add drawings for their logos or for advertisers to add picture-like patterns to the fields. Graphics, whether team names or sponsor logos, are commonplace on grassy sports fields and is a labor intensive process. The task is manual and requiring multiple passes, angling the spray (gun) in several directions to produce visual consistency from all directions. Revenues from selling this type of advertising space is a budget staple for many teams or venues. Typically, only areas of the field that are not used during play are available for advertising, in order to not distract players or disrupt the vision of referees.

Athletics such as American football, soccer, rugby, lacrosse, cricket, hurling, and baseball, are held on the same field at different times but require different sideline markings as well as different markings within the playing field. Even athletic fields dedicated to one sport, such as golf, need to be re-surveyed and re-marked at intervals. Commonly, a tape measure and a rule book are used for marking such fields. However, this method can be inconvenient and time consuming and the accuracy of the markings will vary from time to time. In order to improve upon this method, many fields have installed permanent pegs or upright markers securely anchored to the ground in surveyed locations that can be used for sighting. However, the large number of markers and pegs for several different game markings can give the field a confused appearance and be hazardous. Furthermore, the uprights and pegs are of limited use for marking team logos or advertisements. The appearance can be improved and the hazard reduced by using removable uprights where only the anchor remains in place, however, this is of no benefit for picture-like patterns.

There is a need for a system for automating the marking of surfaces and removal of markings that does not require light or electromagnetic beams, embedded materials, or upright sighting markers that is capable of marking and removing lines and picture-like patterns such as graphics. Augmenting the process with an expanding, foaming marking material would improve the appearance and application process to only require a single, direction insensitive application. Automation of simple stripe painting is becoming more prevalent and single-pass application is desirable.

Current paint formulations used for zone or field marking contain chemicals which one would prefer not to spray into the environment. Even with the most environmentally safe, low to no VOC formulations, repeated use of fillers such as calcium carbonate compact the roots and can kill the grass or adversely affect the synthetic turf infill. Most artificial turf systems include long strands of synthetic fibers stitched onto a backing, which may be a carpet-like material. An infill material is typically brushed into the fibers to build up a layer over the backing. The infill can be formed of crumb rubber or a combination of crumb rubber and sand, or a non-toxic antimicrobial material such as Envirofill. The synthetic strands, infill, and backing are typically laid over gravel or another type of support material to allow drainage of the field after rains. Biocides must be added to paint formulations to keep them stable, which can enter storm runoff and have adverse effects especially on aquatic life.

Another necessary area of improvement versus today's field marking paint is to have a sharp reduction in water usage. A large volume of water is used to dilute the formulations and additionally to clean the spray apparatus after use. Mixing and cleaning up bulk spray applied field marking paint can be such a deterrent, that many fields are hand painted with aerosol cans. This paint can be extremely flammable and may contain up to 90% solvent since aerosol paint cans are exempt from VOC rules based on volume of the can. It would be very desirable if the bulk volume of the paint coating was inexpensive, safe to handle and safe to release into the environment, inert to living things, and to the soil, water and atmosphere.

A major concern for current imprinting applications is the migration of paint or cleaning residue into the synthetic turf infill, which causes densification. Also, the liquids used for imprinting can compromise the turf backing and seam adhesives.

### SUMMARY OF THE INVENTION

A system is disclosed for applying and removing surface markings to and from a surface, the system comprising a vehicle and a spray system, wherein the spray system comprises at least one of a marking fluid, a marking fluid container, a removal fluid, a removal fluid container, a foam generator, and a manifold. The manifold is in fluid communication with at least one of the marking fluid container and the removal fluid container, the manifold further comprising a plurality of valves coupled to the manifold such that a valve cavity is defined between each valve and the manifold, each valve cavity configured to be in fluid communication with the marking fluid container and removal fluid container, and wherein each valve includes a poppet between an opened position and a closed position. A plurality of spray nozzles can be coupled to the manifold, each spray nozzle being in fluid communication with the manifold, wherein when the poppet is moved to the opened position, marking fluid or removal fluid flows from the valve cavity into the spray nozzle. Each spray nozzle is in fluid communication with the foam generator configured to generate a foaming carrier of mono-dispersed emulsions from two immiscible fluids, wherein one of the two immiscible fluids is the marking fluid, the removal fluid, and combinations thereof. A positioning system uses a controller communicatively coupled to the valves, a foam generator, and at least one sensor, wherein the controller is configured to independently control the operation of each valve so as to regulate the flow of marking fluid and removal fluid supplied to each spray nozzle, wherein the flow of marking fluid and removal fluid supplied to each spray nozzle is regulated such that the marking fluid and removal fluid is discharged through the foam generator to generate a desired penetration depth of the surface marking or removal fluid into an area of the surface being marked or cleaned, and wherein the controller is further configured to control displacement of each of the poppets between the opened and closed positions.

Also, a foaming carrier is disclosed comprising at least one of a solution of a primary active agent, a compatible surfactant, a mixture of surfactants, enhancing agents, and secondary active agents.

Also, an aerosol composition is disclosed comprising a propellant, water, a water-insoluble polymer, a surfactant, a foam stabilizing agent, and a solvent that solvates said foam stabilizing agent.

### BRIEF DESCRIPTION OF THE DRAWINGS

FIG. 1 illustrates an exemplary system for applying surface markings to a surface using a vehicle with a spray manifold.

FIG. 2 illustrates an exemplary spray manifold.

### DETAILED DESCRIPTION OF THE INVENTION

The term “liquid” refers to a single liquid, a liquid solution, an emulsion of two liquid phases, a suspension of a solid phase in a liquid phase or a dispersion of a liquid or a solid phase in a liquid phase and the liquid forms a visibly distinguishable layer from a layer of fluid foam formed from the liquid and is in contact with it at the interface between the two layers upon settling down on a horizontal surface.

The term “fluid foam” or “foaming carrier” in the context of this disclosure refers to an aggregate of gas bubbles adhering together and carrying liquid in or around their filmy cell walls, then spontaneously releasing such liquid with time either (a) onto a surface in contact with the fluid foam to wet it or (b) into a container holding such fluid foam to form a liquid phase layer, on the bottom of the container, which is separate and clearly distinguishable from the foam phase layer above it.

The term “active agent or functional active agent” in the context of this disclosure refers to a substance in the liquid, other than a surfactant component, which reacts or interacts with the object surface to accomplish an intended function such as painting, fertilizing, etc.

The term “compatible” means that a particular material or substance being referred to does not substantially adversely affect functional performance or efficiency of a fluid foam of the invention or the performance of its dispenser device.

The term “surfactant” in the context of this disclosure refers to a surface active agent from anyone of the families of anionic, cationic, non-ionic, amphoteric or micro-fine or nanoparticles active agents which changes the interfacial tension between two liquids or between a liquid and a gas. More particularly, it refers to surfactants that are compatible with the active agent(s) and with the components of the dispenser device with which they come into contact, and that cause the formation of bubbles upon agitating such liquid in the presence of gas.

The term “clingability” refers to the ability of a foam to cling or adhere to a vertical surface, measured as of the % of the area covered by the shrinking test foam as a function of time after application. Vertical clingability is defined as the time required for the area of the applied test foam to shrink to 50% of its initial area.

The term “syneresis value” or “foam horizontal thickness half-life” is determined as the time (measured from the start of the test) at which 100(h2/h0) equals 50%, where h0 is the starting foam thickness and h2 is the final foam thickness.

The terms “ground” and “surface” are used interchangeably herein, and both terms refer to a surface upon which a vehicle travels and upon which informational markings are made. The terms “ground” and “surface” refer to both finished and unfinished surfaces, such as paved surfaces, unpaved surfaces, graded surfaces, surfaces to be excavated, original ground lines or elevations, undisturbed soil, etc.

As used herein, the term “paint” refers to any suitable marking agent that can be used to make informational markings on a surface. Thus, the term “paint” includes, but is not limited to, conventional spray paints, roadway lane marking paints, dyes, inks, pigments, colorants and the like.

With regard to the term “liquid propellant” in this disclosure, it is contemplated that such propellant is gaseous at room temperature and atmospheric pressure, but liquid under the pressure within an aerosol can or other container.

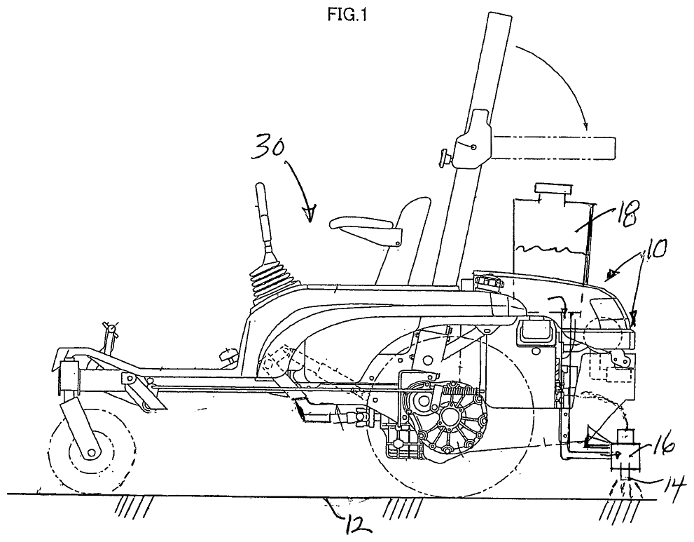

FIG. 1 illustrates an exemplary system for applying and removing surface markings to and from a surface using a vehicle 30 with a spray system 10.

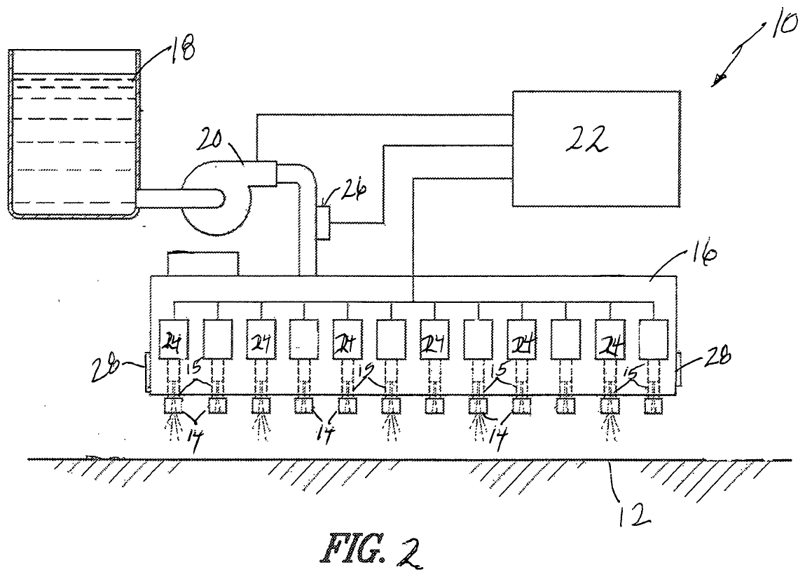

FIG. 2 illustrates a simplified, schematic view of one embodiment of a spray system 10 for applying and removing surface markings to a suitable marking surface 12, such as a road, parking lot, field, wall or other surface. As shown, the spray system 10 generally includes a plurality spray nozzles 14 mounted onto and/or formed integrally with a boom or manifold 16. The manifold 16 may generally be configured to receive paint or any other suitable marking fluid from a container 18 (e.g., a tank or other non-pressurized reservoir and/or a pressurized container) For instance, a suitable pump 20 may be provided between the manifold 16 and the container 18. As such, marking fluid or removal fluid from the container 18 may be pumped into the manifold 16 for subsequent discharge through the foam generators 15 and spray nozzles 14.

The spray nozzles 14 may generally have any suitable nozzle and/or spray tip configuration known in the art. For instance, in one embodiment, the spray nozzles 14 may be configured as a flat fan tip, cone tip, straight stream tip and/or any other suitable spray nozzle and/or tip known in the art. The spray nozzles 14 can also incorporate a foam generator 15 configured to generate a foaming carrier of mono-dispersed emulsions from two immiscible fluids, wherein one of the two immiscible fluids is the marking fluid, the removal fluid, and combinations thereof. The foam generator 15 can be controlled by the controller 22 to vary the penetration depth of the spray.

To control the discharge of paint from the spray nozzles 14 and control the penetration depth of the foaming carrier, the disclosed system 10 may also include a controller 22 configured to independently control a plurality of valves 24 mounted onto and/or within the manifold 16. Specifically, in several embodiments, each spray nozzle 14 may be in fluid communication with one of the valves 24 so that the flow of paint into and through each foam generator 15 and spray nozzle 14 is regulated by its corresponding valve 24. In such embodiments, the controller 22 may be configured to control the operation of each valve 24 so as to provide for independent control of the paint discharged from each foam generator 15 and spray nozzle 14.

The valves 24 may generally have any suitable valve configuration known in the art. For instance, in several embodiments, the valves 24 may be configured as latching solenoid valves, pilot actuated solenoid valves, flipper solenoid valves and/or the like. By configuring the valves 24 as solenoid valves, the valves 24, together with the controller 22, may provide for pulse width modulation (PWM) based control of the flow rate of the paint supplied to each foam generator 15 and spray nozzle 14. For instance, the controller 22 may be configured to supply a regulated current (e.g., via a driver) to the solenoid coil 78 of each valve 24 in order to pulse the valve 24 at a given duty cycle. Thus, by controlling the duty cycle at which each valve 24 is pulsed, the controller 22 may control the flow rate of paint to each spray nozzle 14.

Additionally, as shown in FIG. 2, the controller 22 may also be communicatively coupled to the pump 20 to allow for automatic control of the pressure of the paint supplied to the manifold 16. For instance, the controller 22 may be configured to receive pressure measurements from a pressure sensor 26 disposed downstream of the pump 20 and, based on such measurements, control the pressure of the paint supplied to the manifold 16. Such pressure control may generally allow for control of the droplet size spectrum of the paint discharged from the spray nozzles 14, as such droplet size is typically a function of the fluid pressure and the characteristics of the foam generator 15 and spray nozzle 14.

It should be appreciated that the controller 22 may generally comprise any suitable computer and/or other processing unit, including any suitable combination of computers, processing units and/or the like that may be operated independently or in connection within one another. Thus, in several embodiments, the controller 22 may include one or more processor(s) and associated memory device(s) configured to perform a variety of computer-implemented functions (e.g., performing the calculations disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the controller 22 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the controller 22 to perform various functions including, but not limited to, controlling the operation of the valves 24 and/or the pump 20 and/or various other suitable computer-implemented functions.

Referring still to FIG. 2, the disclosed system 10 may also include one or more position sensors 28 configured to provide the controller 22 with an indication of the actual or relative position of the manifold 16 and, thus, the actual or relative position of the spray nozzles 14 positioned on the manifold 16. For example, in one embodiment, the position sensor(s) 28 provide an indication of the position of the manifold 16 and/or the spray nozzles 14 relative to a starting or reference position. Specifically, as shown in FIG. 1, the manifold 16 may be mounted on a vehicle 30 supported by a plurality of wheels. In one embodiment, the position sensor(s) 28 may comprise one or more global positioning satellite (GPS) receivers configured to provide an indication of the actual and/or relative position of the manifold 16 and/or spray nozzle(s) 14. For instance, the GPS receiver(s) may be configured to receive positioning data from a plurality of different satellites, which may then be correlated by the controller 22 (or the GPS receiver) to the three-dimensional coordinates of the manifold 16 and/or spray nozzle(s) 14. In such an embodiment, the GPS receiver(s) may be configured to provide real time kinematic (RTK) data to allow for enhanced accuracy of the satellite positioning data (e.g., centimeter accuracy).

In other embodiments, the position sensor may comprise any other suitable sensor(s) and/or other device(s) capable of providing an indication of the actual or relative position of the manifold 16 and/or the spray nozzles 14. For example, in a further embodiment, a camera and/or other vision system may be used to detect the position of the manifold 16, in such an embodiment, the controller 22 may be provided with suitable image processing software to allow the images captured by the camera to be analyzed in a manner that permits the relative and/or actual position of the manifold 16 to be determined. For instance, the camera may be disposed at a distal location relative to the manifold 16 such that images may be captured of the manifold as it moves across the marking surface 12. Alternatively, the camera may be mounted directly to the manifold 16 such that images of the environment surrounding the manifold 16 may be captured in order to allow for the actual and/or relative position of the manifold 16 to be determined. It should be appreciated that, when the camera is mounted to the manifold 16, the camera may also be used to detect surface markings. For example, the camera may be configured to capture images of stripes previously marked on a highway. In such an embodiment, the controller 22 may be configured to analyze the images to determine the location of each stripe and, based on such determination, control the valves 24 such that new stripes are painted over the old stripes.

In another embodiment, the position sensor(s) 28 may form all or a part of any suitable positioning system known in the art, such as a laser, sonar and/or radar positioning system. For example, a laser emitting device may be disposed at a distal location relative to the manifold 16 and a corresponding reflector and/or receiver may be mounted onto the manifold 16. In such an embodiment, the laser emitting device may emit a beam of light that is reflected and/or detected by the reflector/detector. Thereafter, the travel time of the light may be analyzed to determine the position of the manifold 16 relative to the laser emitting device.

Regardless of the type of position sensor(s) 28 used, the position information provided by such sensor(s) 28 may generally be utilized by the controller 22 to control the operation of each valve 24. For example, a print file or pixel data map (e.g., a bitmap pixmap) may be stored within and/or received by the controller 22 that includes mapped data corresponding to a desired surface marking. This pixel data map may then be correlated to the area across which the surface marking is to be applied. For instance, the dimensions of the pixel data map may be scaled to the corresponding area of the marking surface 12. Thereafter, as the manifold 16 is moved across the marking surface 12, the controller 22 may individually control the valves 24 based on the position information such that each valve 24 is activated as it passes over a location on the marking surface 12 at which paint is to be applied

Carrier fluid foam formed by the foam generator 15 can be used for preferential distribution and penetration depth control of products on plants or other plant-like structures. Expanding or expanded carrier delivers pigment, paint, removal, chemical products to plants, lawns, fields, covered areas and landscapes in a controlled manner to allow ‘tuning’ of the penetration depth of the product. Carrier product chemistry and delivery system tailors coverage characteristics of single nozzle or multi-nozzle sprayers or foam generators. Chemistry and delivery system parameters produce contiguous product coating throughout intricate structures or layered surface coating above intricate structures. Post effervescence, the carrier can evaporate as the product condenses or coalesces on intended surfaces.

An exemplary embodiment of the carrier fluid foam can contain (a) a solution of the primary active agent, (b) a compatible surfactant, or a mixture of surfactants, in a concentration range of 0.05 to 20%, such as a cocamine oxide, (c) other optional enhancing agents, such as compatible dyes, and (d) one or more optional additional compatible secondary active agents. The fluid foam composition has a combination of functional performance characteristics that provide greatly improved efficiency to the product. The functional performance characteristics of the composition foam are (a) a foam syneresis value in the range of 1 to 60%, preferably 2 to 40%, (b) a foam horizontal thickness half-life of at least 2 seconds, and (c) a foam vertical-surface clingability of at least 2 seconds. Because of this combination of characteristics, the present composition carrier fluid foam brings into contact with an applied surface substantially larger amounts of active agents for longer reaction times than is provided by known compositions of equal concentrations applied to a surface in the form of a sprayed liquid, a short-lived foam, a thickened liquid or a gel. The superior efficiency of the carrier fluid foams disclosed herein compared to other known products of similar composition is believed to be a result of the liquid-rich cells of the carrier fluid foam clinging strongly to the applied surface and said cells breaking up slowly so that a continuous source of the active agent(s) is efficiently delivered to the applied surface. Thus, a carrier fluid foam of the present disclosure has a longer contact time with the applied surface and provides a greater amount of primary agent(s) to attach to the intended object.

Suitable primary functional active agents include: organic acids, and inorganic acids; aldehydes, ketones, simple straight chain mono-functional alcohols; mono-functional ethers; esters; organic bases; and, alkali metal hydroxides, carbonates and silicates; oxidizing agents and bleaching agents; terpenes; mixtures of a surfactant and a chelating agent; topically applied liquid medications and disinfectants; commercially formulated liquid cleaners; lubricants; and chemicals used in household, industrial, agricultural, and institutional applications; cosmetics; pharmaceutical applications; and quaternary ammonium compounds.

Examples of suitable organic and inorganic acids include acetic acid, oxalic acid, citric acid, sulfuric acid, hydrochloric acid, nitric acid, phosphoric acid and sulfamic acid and salts thereof. Examples of suitable organic bases include amines, salts of amines and salts of ammonia. An example of a suitable amine is monoethanolamine. Examples of suitable alkali metal hydroxides, carbonates and silicates include sodium hydroxide, potassium hydroxide, lithium hydroxide, sodium carbonate, potassium carbonate, calcium carbonate, lithium carbonate, sodium metasilicate and sodium orthosilicate. Examples of suitable oxidizing and bleaching agents include sodium chlorite, potassium chlorite, lithium chlorite, hydrogen peroxide, and alkali metal hypochlorites such as sodium hypochlorite, potassium hypochlorite and lithium hypochlorite. Examples of suitable quaternary ammonium compounds include alkyl dimethyl benzyl ammonium chloride, alkyl dimethyl ethyl benzyl ammonium chloride, alkyl dimethyl benzyl ammonium bromide, alkyl dimethyl ethyl benzyl ammonium bromide and alkyl dimethyl ammonium saccharinate. An example of a suitable mixture of a surfactant and a chelating agent is a cocamine and a chelating agent like ethylene diamine tetraacetic acid. Examples of suitable topically applied liquid medications include disinfectants, coagulants, anesthetics, antibiotics and anti-bacterial agents and particularly include hydrogen peroxide, and ethanol.

Additional examples of suitable functional active agents include: methyl alcohol, ethyl alcohol, propyl alcohol, butyl alcohol and other higher molecular weight straight chain mono-functional alcohols; dimethyl ether, methyl ethyl ether, diethyl ether, and other higher molecular weight mono-functional ethers; and methyl acetate, ethyl acetates, propyl acetate, amyl acetate, and other higher molecular weight esters.

Suitable surfactants include those selected from surfactant families that are capable of converting the particular precursor liquid composition to fluid foam and that are also compatible with the one or more primary active functional agents used including the chemical families of anionic, cationic, non-ionic and amphoteric surfactants and combinations thereof. Suitable surfactants must meet two tests of compatibility with the functional active agent. The first is a foaming test which shows that the solution comprising the surfactant and active agent does indeed form a thick fluid foam when agitated vigorously in the presence of gas or compressed air. The second test is a shelf life stability test. It should show that the surfactant and active agent do not interact substantially adversely over a long period of several months. This test requires chemical and/or physical measurements of changes in solution stability indicator properties such as pH, temperature, color, phase change, etc.

Other suitable formulations and agents are described in US Patent Application US20050239675A1 to Makansi, entitled “Carrier foam to enhance liquid functional performance”, the entirety of which is incorporated herein by reference.

Aerosol Foam Marking Compositions: Another exemplary embodiment of the present invention provides an aerosol composition that provides a foam upon discharge from a suitable containment means, the composition comprising (a) a propellant, (b) water, (c) a water-insoluble polymer, (d) a surfactant, (e) a foam stabilizing agent, and (f) a solvent that solvates said foam stabilizing agent. For the propellant, the marking embodiment contemplates the use of any type of propellant or mixture of propellants that will assist in the formation of a foam upon discharge of the composition from a containment means. Typically, liquid propellants are used to provide the requisite foaming characteristic.

It is not critical to the marking embodiment whether a water-miscible or water-immiscible liquid propellant is used so long as the composition emerges from the containment means as a foam. In addition, the liquid propellant selected should be inert, i.e., it should not react with the components of the composition. One example of a water-miscible propellant is dimethyl ether. The ethers may be used in the present inventive compositions with some degree of success; however, they are not favored due to their cost in comparison to other available propellants. Water-immiscible propellants contemplated by the marking embodiment include non-halogenated hydrocarbons other than the ethers, e.g., methane, ethane, propane, and butane, and halogenated hydrocarbons, e.g., Freon 134, as well as mixtures of these various water-immiscible propellants. Use of the halogenated hydrocarbons is presently on the decline, however, due to environmental concerns over their effect on the ozone layer surrounding the earth. As such, use of these types of propellants is not preferred.

Gaseous propellants, i.e., those which remain as a gas when under pressure in an aerosol can, may also be used. As with the liquid propellants, the gaseous propellants should not react with the other components. Examples of suitable gaseous propellants include nitrogen, carbon dioxide, nitrous oxide, argon, helium, and mixtures thereof. To achieve the formation of a foam, a mechanical break-up actuator should be used to provide for atomization of the composition upon discharge. Any type of suitable actuator may be employed, these type of actuators being well known to those skilled in the art.

The quantity of propellant utilized will vary based upon the specific aerosol foam composition formulated. The proportions of the other ingredients in the aerosol as well as the amount of the composition present in the container should be taken into account. Generally, the amount of propellant present should be that which is sufficient to expel substantially all of the composition from the containment means. The sufficiency of propellant, either liquid or gas, in an aerosol container is typically determined by reference to the vapor pressure inside the can. Generally, when the pressure in the can reaches a range of from about 30 to 110 psig at 70° F., a sufficient amount of propellant has been introduced. Preferably, the initial container pressure ranges from about 40 to 80 psig.

In order to reach the aforesaid pressures, the propellant, if a liquid, is generally present in an amount ranging from about 5 to about 40 wt. percent of the composition. Preferably, about 15 to about 25 wt. percent of liquid propellant will be in the composition and most preferably about 18 to 22 wt. percent. If, for example, dimethyl ether is used, amounts at the higher end of the range will be necessary due to its characteristic lowering of vapor pressure upon exposure to solvents. Most liquid hydrocarbons and halogenated hydrocarbons do not suffer from this loss of vapor pressure effect and may therefore be present in amounts ranging toward the lower ends of the aforesaid ranges. Further, the other propellants are typically less expensive than dimethyl ether and are less flammable, such that hydrocarbons other than the ethers are the preferred propellants. When gaseous propellants are used, they will be generally present in an amount which is substantially less, on a weight basis, than a liquid propellant. As such, gas propellants are present in an amount ranging from about 0.1 to about 10 wt. percent of the composition. Preferably, about 0.5 to about 5 wt. percent of gaseous propellant will be in the composition and most preferably about 1 to 3 wt. percent.

Another component utilized in the marking embodiment may be generally described as a polymer. This component assists in stabilizing the resulting foam. A water-insoluble polymer is preferably employed for that purpose with acrylic polymers being particularly appropriate for use herein. One preferred group of polymers contemplated by the marking embodiment consists of interpolymers of (i) units from at least one neutral free-radical polymerizable ester having a vinylidene group attached to the functional group, which ester by itself yields a soft linear polymer, for example an acrylic, (ii) units from at least one neutral polymerizable aromatic monovinylidene compound which by itself yields a hard polymer, such as styrene, and (iii) units from at least one neutral polymerizable aliphatic monovinylidene compound substituted by a cyano group and which by itself yields a hard polymer, for example, acrylonitrile. Exemplar of polymers of this type, in aqueous dispersion form, are available from Rohm & Haas, Inc. under the designation “W.L.”, for example “W.L. 91.” This W.L. dispersion consists of a copolymer of styrene, acrylonitrile, and an acrylate ester present in an amount ranging from about 40 to about 43 wt. percent and a surfactant present in an amount ranging from about 4 to about 6 wt. percent of the dispersion, the balance being water. These type of polymers, i.e., the W.L. series, generally have a molecular weight of about one million.

The amount of polymer included in the composition is that amount which will result in a foam having the desired longevity. However, the amount of polymer, in addition to other solids, must be limited such that the total solids content is low enough to allow the composition to be discharged from a standard type of actuator, i.e., without the need for a specialized mechanical break-up type of actuator, when a liquid propellant is used. The ability of the liquid propellant containing composition to be discharged from a standard aerosol can and actuator illustrates one of the economic advantages associated with the marking embodiment. Generally, the amount of polymer solids present in the composition which is adequate to accomplish the foregoing when use of a liquid propellant is contemplated ranges from about 1 to about 25 wt. percent of the total aerosol composition, preferably about 2 wt. to about 15 wt. percent, and most preferably about 3 to about 15 wt. percent of the aerosol composition. Under this scenario, the total solids content should generally range up to about 5 wt. percent of the composition. When a gas propellant is utilized, the solids content may be increased, this ranging from about 15 to about 20 wt. percent of the composition.

The water component of the marking embodiment is generally present in an amount sufficient to allow adequate dispersion of the components as well as to provide the viscosity level necessary for the liquid propellant containing composition to be discharged successfully through a standard actuator. This amount will generally range from about 10 to about 90 wt. percent, preferably from about 40 to about 80 wt. percent, and most preferably about 50 to about 70 wt. percent of the composition. A composition that is comprised of at least about 50 wt. percent water is preferred.

The surfactant used in the marking embodiment has a dual role. More specifically, this component will act as a dispersant for a foam stabilizer as well as a foam-inducing agent. As such, the surfactant selected for use in the present composition may be of any type which is suitable for providing adequate dispersion of the foam stabilizer and other solids throughout the composition such that same may be discharge through a standard actuator, or a mechanical break-up actuator if a gas propellant is utilized. Adequate solution of the composition is achieved when the foam stabilizer, which will be discussed presently, is fully dissolved. Further, the surfactant must be capable of inducing foam production upon discharge of the composition from the containment means. If the polymers selected are those which are already in the form of an aqueous dispersion, e.g., the Rohm and Haas W.L. series, the amount of surfactant associated with the polymer resin is generally sufficient. However, and depending upon the degree of foaming desired, it may be desirable to introduce additional amounts of surfactant into the composition. Further, as additional components are added to the composition, such as pigments, increased amounts of surfactant, as a dispersant, may be advantageously added. Typical surfactants which may be used in the aerosol compositions of the present application lauryl sulfate, lauryl ether sulfate, and mixtures thereof. Exemplar of a surfactant which may be added to the composition is Sipon NA-61 (sodium laureth sulfate). The amount of surfactant present generally ranges from about 0.1 to about 15 wt. percent, preferably about 1 to about 10 wt. percent, and most preferably about 1 to about 5 wt. percent of the solution.

The marking embodiment composition can further incorporate a foam stabilizer or stabilizers which, as their name implies, act in concert with the other components to stabilize the resulting foam for a predetermined period of time such that foam longevity is enhanced. Suitable foam stabilizers include the higher fatty alcohols such as decyl alcohol, lauryl alcohol, tetradecyl alcohol, cetyl alcohol, oleyl alcohol and stearyl alcohol, fatty monoglycerides such as glycerol monolaurate and glycerol monostearate, amides such as stearic acid amide and stearic acid ethanolamide, amines such as alkylmethylamine oxide, N-higher alkyl hydroxyalkyl carbamates such as N-dodecylhydroxyethyl carbamate, and Sulfobetaines® such as alkyl amino propyl sulfonic acids. Advantageously, the higher fatty alcohols, such as cetyl and stearyl alcohol, are employed.

The marking embodiment of the present composition can employ both cetyl and stearyl alcohol as the stabilizing agent. The rationale behind this is in part due to the characteristics of the individual components as well as their collective effect on the composition. More specifically, cetyl alcohol (I-hexadecanol), by itself, will stabilize the composition and the resulting foam adequately at low temperatures, i.e., about 50 to 100° F. When exposed to higher temperatures however, i.e., about 100 to about 120° F., the composition breaks down and is no longer adequately dispersed in water. It has been discovered that the addition of stearyl alcohol, which itself is not an outstanding stabilizer as compared to cetyl alcohol, will stabilize the dispersion even at these higher temperatures such that cetyl alcohol's sensitivity to the aforesaid high temperatures is overcome. Thus, the present invention has discovered a composition that is relatively insensitive to changes in temperature that might occur due to prolonged storage or production methods. The total amount of stabilizers present generally ranges from about 0.05 to about 10 wt. percent, preferably about 0.1 to about 5 wt. percent, and most preferably about 0.5 to about 3 wt. percent of the solution. When the two preferred components are used, the mixture should be about two parts cetyl alcohol to about one part stearyl alcohol.

One or more solvents may also be utilized in the marking embodiment, these components being adapted for solvating the aforesaid foam stabilizing agents. As will be explained in greater detail in a subsequent section, salvation of these stabilizing agents is required so that the composition of the marking embodiment may be properly prepared. Any solvent or combination of solvents may be used which acts to dissolves the stabilizer and coalesce the polymer. Examples of these solvents include lower monoalkyl ethers of ethylene or propylene glycol, such as propylene glycol methyl ether and ethylene glycol butyl ether. Generally, these solvents are present in an amount that is sufficient to fully solvate the foam stabilizing component, however, additional amounts may be added if desired. The specific amount used in the marking embodiment will typically range from about 3 wt. percent to about 15 wt. percent, advantageously from about 6 wt. percent to about 12 wt. percent, and most preferably about 7 to about 10 wt. percent of the composition.

While the aforementioned compositions will, upon discharge, produce a white colored foam, a pigment may be further included in the composition such that a color is imparted to the resulting foam. As such, an amount of pigment which is appropriate to obtain the desired degree of pigmentation will be included in the composition. The pigment may comprise any convenient pigment which will provide a colored resulting film, for example, organic, 10 inorganic, fluorescent, metallic pigments, retro-reflective pigments and mixtures thereof. The amount of pigment, when same is included in the present inventive composition, ranges from about 0.5 to about 25 wt. percent, preferably from about 1 to about 15 wt. percent, and most preferably about 2 to about 10 wt. percent of the composition. However, the overall composition solids content should be kept in mind when adding pigments to the composition. This is especially the case when a container having a standard actuator is used.

When a pigment is included in the composition, the quantity of polymer will generally be lower, e.g., toward the lower end of the range recited previously. If a pigment is not included, the amount of polymer will generally be higher, e.g., toward the higher end of the previously recited range. Another method can deliver a foam base layer, sometimes referred to as a canvas, which accepts a secondary application of a marker or color.

Thickeners may also be employed in the marking embodiment composition such as natural or synthetic gums, e.g., xanthan gum, starch, associative thickeners, and mixtures thereof. These components are used to adjust the viscosity of the composition to a predetermined range, this range ultimately affecting the degree of foam “billowing.” As such, the addition of this component will have an effect upon the height of the foam produced. Further, this thickener serves to reduce water drainage from the resulting foam, this tending to positively affect the stability of the foam. These thickeners are usually present in a total amount ranging from about 0.05 to about 2 wt. percent, preferably about 0.1 to 1 wt. percent, and most preferably about 0.1 to about 0.5 wt. percent of the composition.

A foam-boosting agent may be optionally employed such that the foam forming characteristics of the marking embodiment are enhanced. Specifically, this additive increases the viscosity of the aqueous phase such that foaming of the composition during discharge is enhanced. Generally, any known enhancer may be used, with alkanolamides and amine oxides being advantageously employed. Particularly preferred is Cyclomide DC 212 (Costec) which consists of Cocamide DEA (2:1 diethanolamide). Examples of other foam-enhancing components include detaines, amides, and mixtures of these which have the requisite effect during discharge. While the foaming agent is generally used in an amount sufficient to provide the desired level of foaming of the composition upon discharge, quantities ranging from about 0.1 to about 3 wt. percent, preferably about 0.1 wt. percent to about 2 wt. percent, and most preferably about 0.5 to about 1.5 wt. percent of the composition are typically employed.

Eliminating corrosion of the inside of aerosol containers is also a concern with aerosol compositions. One method of eliminating or reducing such corrosion is to provide the composition with an overall pH value in the range of from about 7.2 to about 10 by introducing a suitable stabilizing component, such as ammonia or morpholine, in the composition in a corrosion inhibiting amount, generally up to about 1 wt. percent of the composition. This effect may also be provided with a component such as Raybo 60 (Raybo Chemical Company) the active ingredient of which is an alkylamine. Other suitable inhibitors include amines, nitroparaffins, nitrites, and mixtures thereof. This type of component inhibits can corrosion and is usually present in a corrosion inhibiting amount, generally from about 0.1 to about 4 wt. percent and preferably from about 0.5 to about 3 wt. percent of the composition. Most preferably, the corrosion inhibitor is about 0.5 to about 1.5 wt. percent of the composition.

A preservative may also be added to increase the longevity of the marking embodiment composition. Although any type of preservative which acts to prevent bacterial and other unwanted growth may be used, Cosan 145 (Cosan Chemical Company, Carlstadt, N.J.) may be advantageously employed. Cosan 145 is a liquid organic preservative recommended for use in resin emulsions which provides antimicrobial protection to water-based systems. This type of component is usually present in a bacterial or growth inhibiting amount, this amount usually ranging from about 0.05 to about 2 wt. percent and preferably from about 0.1 to about 1 wt. percent of the composition. Most preferably, the preservative is about 0.5 to about 1.5 wt. percent of the composition.

The procedure by which the present composition is produced is critical to the stability of the resulting foam. The general procedure for producing the foam composition comprises mixing all but about one percent of the solvent, stabilizers, and surfactant until the stabilizers are solvated. About one-third of the water is then added to the aforesaid mixture to form a second mixture. This second mixture is then agitated until all components are thoroughly mixed. After the agitation of this second mixture, this second mixture is slowly added to a third mixture containing a resin emulsion and about one-third of the water. The remaining water and additional components (except for the thickeners and remaining solvents) are added to form a fourth mixture. Finally, the thickener and the remaining solvent should be pre-mixed such that the formation of lumps is prevented. This thickener/solvent mixture is then added to the fourth mixture to form the final composition. This composition is then agitated until its viscosity stabilizes. The final composition is then introduced into a suitable reservoir or aerosol container having a mechanical break-up actuator (to produce the desired foaming of the composition if a gas propellant is used) or a standard actuator (if a liquid propellant is used) with the propellant then being injected therein.

Other suitable formulations and agents are described in U.S. Pat. No. 5,156,765 to Smrt, entitled “Aerosol foam marking compositions”, the entirety of which is incorporated herein by reference.

Short Term Aerosol Composition: In some cases, the desired task or action requires the use of temporal markings to be placed outdoors, where the marking is exposed to different environmental conditions as wind, sun, dampness or rain that can affect the integrity of the marking or the rate on which said marking disappears, which causes that the action or task that needs the use of temporal markings cannot be conducted in a suitable way. The ease of generating the marking is also an important desirable feature, since the action or task may require quickly or even simultaneously drafting of multiple markings of different forms and sizes in a determined frame of time. For example, in the case of tasks that require markings drafted on horizontal or inclines surfaces, as the athletic field.

The temporal embodiment of this invention consists of an aerosol composition that allows to generate short term or temporal markings in diverse types of surfaces, in such a way that the marking has a certain duration that allows to perform some desired actions and after that, it vanishes without any remaining spot or evidence that it existed; the duration of the marking is of among 1 minute to 10 days, the combination of the components that integrate the composition for aerosol, as well as the conformation of the discharge nozzle insert of the container in which the above mentioned composition is supplied, allows to draft the marking to a distance of up to 1 meter from the surface in which the marking is drafted. The temporal composition can additionally comprise, in other preferred embodiments, at least a foam stabilizer and at least one component that allows setting the lifespan of the marking.

To facilitate the visibility of the marking, in surfaces where there are no color contrast or where it is needed the use of markings of different colors or where there are assigned specific meanings to certain colors, in one of the temporal embodiments of the present invention the composition provides color markings, where the composition contains at least a compound providing color to the marking. The composition of the present invention, in a temporal embodiment, includes at least one foam former and a foam stabilizer.

Regarding its toxicology, the composition of the present invention does not generate any adverse effect on the user who drafts the marking or on those that, for the action to be performed, could be in touch with the composition producing the marking, likewise it does not generate any adverse effect to the environment, including to the surface itself where the marking is drafted.

The surface in which the marking is drafted with the product object of the present invention can be of diverse substrates like for example, stone, wood, synthetic grass, natural grass, carpets, soil, metal, marble, floors covered with polymers such as epoxidic products or polyurethanes, plastic or glass, in a general way, it can be applied on any type of substrate, due to the nature of the components no adverse effect is generated on the substrate and as soon as the marking has vanished, no evidence remains of the same nor damage on the surface substrate.

One of the temporal embodiments includes at least water, at least the foam forming, at least one foam stabilizer and at least one propellant. The foam forming is selected of between an alkyl sulfate, an alkyl ether sulfate or mixtures thereof. Optimally, it is preferred the use of some of the members of the group formed by the sodium lauryl sulfate, monoethanolamine lauryl sulfate, diethanolamine lauryl sulfate, triethanolamine lauryl sulfate, sodium lauryl ether sulfosuccinate, sodium lauryl ether sulfate, or mixtures thereof in a concentration in the composition of between 0.10 and 5.0% in total weight.

Optionally, relations of between 1:3 to 19:1 are preferred when it is used a mixture of two foam forming compounds, wherein indistinctly are selected from the group comprised by the sodium lauryl sulfate, monoethanolamine lauryl sulfate, diethanolamine lauryl sulfate, triethanolamine lauryl sulfate, sodium lauryl ether sulfosuccinate, sodium lauryl ether sulfate.

A suitable foam stabilizer is an aliphatic amide of fatty acids, it is preferred the use of any of the compounds of the group comprising diethanolamides of fatty acid, cocodiethanolamide , monoisopropanol amide of coconut fatty acids, diethanolamide of oleic acid, diethanolamide of palm fatty acids or mixture thereof in a concentration of between 0.1% and 5.0% in total weight of the composition.

Optionally, relations of between 1:1 to 9:1 in weight are preferred when it is used a mixture of two foam stabilizers indistinctly selected from the group comprising diethanolamide of fatty acids, cocodiethanolamide , monisopropanol amide of coconut fatty acid, diethanolamide of oleic acid, diethanolamide of palm fatty acids or diethanolamide of coconut fatty acids.

Additionally the composition contains at least a propellant that allows in conjunction with the other components to achieve the wished effect of generating a temporal marking, this one is selected from the group comprising propane, butane, isobutane or mixtures thereof. And the propellant is in a relation to the rest of the components of the mixture of between 1:49 to 1:2 in weight.

Optionally, when it is used a mixture of two propellants it is preferred relations of between 1:4 to 17:3 in weight, wherein, indistinctively they are selected from the group comprising propane, butane and iso-butane.

Optionally, when it is used a mixture of three propellants it is preferred a relation of between 1:2:3 to 20:1:2 in weight, wherein indistinctively they are selected from the group comprising propane, butane and iso-butane. Additionally, the composition can contain at least a foam duration term regulator in order to control the time of permanency of the marking according to the action that is needed and the climatological conditions to which the applied foam can be exposed.

In the embodiment in which the composition includes a term regulator of the duration of the formed foam, this is selected from the group comprising glycerin for instances chemically pure, technical degree, pharmaceutical degree or not refined degree; water soluble glycols, as the propylenglycol, or mixture thereof, in a concentration of between 0.01 and 4.0% in total weight of the composition.

In addition, optionally the composition can have a selected color due to the presence of at least a component that gives color and at least a pH regulator, which allows to generate color markings with the advantage of any remaining marking or permanent spot of the color unlike the colored foams or aerosols known in the prior art which produces permanent spots which requires later washing of the surface or even, the need of using organic solvents.

The provision of color marking under the temporal embodiment results in a higher applicability to the invention, since it is possible to use it in those actions or tasks requiring the use of markings of different color or where some particular meaning is given to specific markings of certain colors, with the advantage that the invention prevents the formation of permanent or lasting marks, it is to say, that the color vanishes together with the marking.

The component that provides color to the marking has the property of changing from a specific color to colorless depending on the pH of the composition, which do not allow that any permanent colored markings remain. The composition is stable enough to prevent the change of color during the required time for the marking to be visible and stable. Thus, the color will be kept stable up to 10 days as the drafted marking in turn vanishing at the same time that the rest of the components.

The component that provides color to the foam is selected from the group comprising 2,4-dinitrophenol, (3,3-bis-(4-hidroxyphenyl)-1-(3H)-isobenzofuranone, 3,3-bis-(4-hydroxifenyl)ftalide), trinitrobenzoic acid, (3,3-bis (4-hydroxi-5-isopropyl-o-toly 1) ftalide, m-nitrophenol, nitramine, o-cresolphtaleine, p-nitophenol, or a mixture thereof in a concentration of between 0.001% and 2.0% of the total weight of the composition.

A pH regulator component of the composition is selected from the group comprising 2-amino-2-methyl-1-propanol (AMP), 2-dimethylamino ethanol (DMAE), diglycolamine (DGA), methylaminoethanol (MAE), monoethanolamine (MEA), triethanolamine (TEA) or a mixture thereof in a concentration of between 0.01 and 2.0% of the total weight of the composition. In addition, the composition may contain at least a solvent that facilitates the incorporation of the component that provides color to the composition, is preferred the use of ketones, alcohols or mixtures thereof, even more preferred it is the use of ethyl alcohol, propanone or a mixture thereof and it is in a concentration of between 0.01% and 5.0% weight of the total weight of the composition.

The temporal marking formed from the described composition is stable up to 10 days to a temperature of up to 50° C., in conditions of dampness of between 30 up to 100% of relative dampness, for stable being understood that it preserves its volume, continuity of the marking and therefore visibility to long distances, allowing to perform the action for which the marking is needed. The modulation or adjustment of the component quantities allows to control the foam duration according to the needs and characteristics of the action or task for which the marking is provided.

The composition object of this temporal embodiment allows to generate markings with a volume of bubble controlled such that it is possible to visualize them from long distances and not to give place to any type of confusion regarding the position of the marking. The composition has the additional advantage of requiring a minor quantity of material, with respect to foams known in the prior art to generate a markings of similar dimensions, which results in the possibility of generating a bigger number of marking units or requiring smaller containers to canning or packing the composition.

Another additional advantage provided by the composition of the temporal embodiment is not to need of the use of biocides since the composition is biological stable. Likewise, another advantage is that the composition of the invention is not flammable which eliminates the risk for the user who drafts the marking and for those who use the markings; the inflammability of the composition was determined using the method ASTM D3065-01 “Standard test for flammability of aerosol products”, section 4 “flame projection test”, the method indicated in the point 31.6 “Aerosol foam flammability test” of the document “Recommendations on the transport of dangerous goods, United Nations, 2009, Rev. 5” y the Directive 75/324/CEE from the European Union.

The temporal composition is packed in a container for aerosol what facilitates its application, additionally the container and the valve associated to the activator has an ergonomic form to even more facilitate the application, the material of the container can be of steel, aluminum, plastic, PET or glass, the packages of aluminum are preferred due to its minor weight and higher resistance to the pressure. The temporal composition itself allows to generate temporal markings with each of the advantages and characteristics already mentioned, but additionally the effect is improved with respect to the height of application and the homogeneity of the marking through the use of a discharge insert operatively associated with a valve activator for expelling aerosol, the discharge insert having an discharge orifice of a diameter of between 0.0254 cm to 0.1143 cm.

Additionally, pressure driven microfluidic devices can create mono dispersed emulsions and bubbles from two immiscible fluids to create a foaming carrier. All of the devices function in some way to inject a dispersed phase (fluid one, for example air) into an immiscible continuous phase (fluid two, for example paint). If both fluids are liquids then an emulsion is formed. If fluid one is a gas, discrete bubbles are formed and may be dispersed as foam. Foam generated from mono dispersed bubbles has increased stability compared to other randomly sized bubble foams, as there isn't a pressure difference between bubbles in contact, severely limiting one mechanism of foam coarsening. If two partially or fully miscible fluids are used, the same device can be used for mixing or dilution, with or without the further addition of an immiscible fluid to make a second phase.

Controlled bulk foam, or the foaming carrier described herein can be in formulations of disinfectant or cleaners for use on artificial turf fields. Turf fields need to be cleaned and disinfected periodically to control dust and to eliminate the viruses and bacteria that grow on the turf and infill. Disinfectants can pose serious health risks to the chemical applicator and to the users of the field, so that the fields are typically shut down while the chemicals are applied and dried adequately, until once again it is considered safe to play on. Or worse, the fields are not shut down, exposing players to disinfectant or cleaners that have not sufficiently dried. Migration of paint or cleaning residue into the synthetic turf infill causes densification which negatively affects turf performance. Also, the liquids used for imprinting can compromise the turf backing and seam adhesives.

Disinfectants are diluted typically with large volumes of water before application. With controlled, bulk foams, the air acts as the diluent insuring that the correct disinfectant dosage is applied to the turf, preferentially delivered from a closed system using ambient air so that there is no exposure to the chemicals. The formulation may be modified such that the air stays entrained in the solution for an adjustable amount of time (i.e. the foam stability is controlled) so that the disinfectant is delivered to the intended target. Since substantially less water is used, the total time to apply and dry is reduced.

With controlled, bulk foams, further modification of the chemical formulation may take advantage of one or more properties of the incorporated air. The air void size and volume fraction may be controlled such that they render the formulation opaque. In this case, having uni-modal size of the voids increases persistence of the foam. This improves over distribution of void sizes which tends to coarsen foam and pop individual bubbles/cells since different void sizes also have different void pressures, and foam naturally equilibrates.

The chemical formulation may also include materials to stabilize the foam, as well as a polymer or other film forming material to set the dried applied foam, such that white marking lines with a definable persistence are created. These formulations may be prepared as concentrates, used in low volumes, thereby saving water; and without necessarily adding fillers such as calcium carbonate or titanium dioxide. These formulations may also be dyed or pigmented in order to make colored lines.

Orientations of individual bubble generators for making the foaming carrier can be manufactured to create custom foams with controlled void sizes and placement. Criteria that need to be maintained for successful array bubble generators include the decoupled fluid stream virtual orifices, feeder and distribution channels that maintain consistent flow of fluid two to each bubble generator, and consistent pressure of fluid one to each bubble generator. The positioning of bubble generators in the array determines whether the array creates bubbles or foam, however individual unimodal bubbles delivered to a flat surface demonstrate crystalline behavior and will self-assemble into ordered foams.

Variations of scaled arrays of bubble generators with decoupled orifices may be manufactured using 3D printing techniques. Conventional micro droplet and bubble generators (e.g. flow focusing Y or T junction, etc.) may similarly be designed and manufactured with decoupled orifice designs to produce similarly improved bubbles and foams. The minimum design feature sizes, and therefore the generated bubble sizes, are also dependent upon the fabrication techniques and construction materials used. Alternative to 3D printing, standard or other device fabrication techniques (for instance in creating a PDMS type flow focusing device) may be used to create decoupled orifice generators.

Controlling exit placement or varying geometry at select exits, during printing or manufacturing, allows consistent production of bimodal foams to improve properties. For example, in emulsion chemistry the number of unimodal large droplets might be set at four times the number of unimodal small droplets (an “80/20 packing”) in a batch with a typical size regime ranging from 50 nm to 450 nm. This “80/20 packing” with two distinct size modes greatly enhances final properties, for example surface characteristics (i.e. packing at the surface upon film formation), even though the placement of large and small droplets from the bulk liquid in the film formed state is somewhat random. Such “80/20 packing,” with ordered structuring of precise and constant bubble and foam sizes, will also allow improvement of current known ratios and resulting properties.

Air and carbon dioxide are preferred gasses for use as fluid one. The bubble generator will also function with other compressed gas compositions delivered from tanks, reservoirs or pumps. Fluid one pressure ranges are preferably within 0.1 to 20 PSI. With high viscosity fluid two compositions, higher pressures may be required to create bubbles.

A wide range of fluid two compositions may be used to create uni-modal bubbles and custom foams for specific end use applications. Solutions, emulsions and suspensions with particle sizes and viscosities ranging over several orders of magnitude are all effective, provided that: fluid two contains a surface active ingredient to stabilize the resulting bubble; the liquid readily flows through the device; and the fluid two liquid is more hydrophilic then fluid one.

Examples of fluid materials suitable for use in field painting include dispersants, thickeners, emulsion polymers, acrylic emulsion polymers, styrene acrylics, vinyl acrylics & acetates, and crosslinkers; all materials as manufactured by McTron Technologies.

Other suitable formulations and agents are described in WO 2016/063260 to Marin-Valdez, entitled “Short term aerosol composition for marking or delimiting any type of surface”, the entirety of which is incorporated herein by reference.

Positioning System Controlled Paint Sprayer System—Systems for changing the color or hue of turf employ technology developed for related effects, such as field painting and chemical fertilization. Dramatic image quality can be realized by dispensing variations of white, red, green, and blue or cyan, magenta, yellow and black. Here, standard dot matrix printing concepts and technology are scaled to larger dispensing systems, providing increased image quality and contrast over the cutting or bending methods described in this document. Painted images are produced with the same transport and control system described above. Liquid media are dispensed by media injectors located within the implement's delivery system. The mechanism's chemical injectors receive control signals which open and close mechanical valves. Individual valves control the amount and placement of media. In the case of colored imprinted imagery, a series of red, green, and blue (or cyan, magenta, and yellow, etc.) injector nozzles project a fan-type pattern; thus defining one pixel of an image matrix. A series of multi-color nozzles is spaced along the length of a spray bar to avoid gaps between the fan patterns, or pixels.

A variation of imprinting with colored media includes chemical based turf treatments that affect the chlorophyll or appearance of turf. This approach has long lasting effects compared to the relatively short term effects imparted by bending or mowing. For liquid chemical treatments, the delivery system is similar to the color media delivery system described above. A series of multiple nozzles can be used in a manner that is similar to that of the color application described above. In the case of a chemical treatment application, various chemicals can be applied preferentially. For example, turf health enhancing chemicals can be applied in zones or pixels to enhance the value of the green color in turf appearance at that location. Complementary chemicals can be applied to the turf at other locations that negatively affect the plant's chlorophyll, thus producing contrasting color attributes, such as pale green or other colors.

Powder or granular paint or chemical treatments can be applied with delivery systems that complement traditional systems that distribute conventional white lime product or fertilizers. For these systems, media wheel driven hoppers agitate and dispense the paint and/or chemicals through control gates that receive instruction signals from the system controller. In all applications, selected ratios of chemical treatments, or red, green, and blue color media are dispensed by the implement to produce the intended effect. The timing and duration of paint and/or chemical application are used to control the placement of imprint features.

Almost any positioning system, as described above, can drive a paint spray system that can include a paint sprayer including a receiver and an external computer including an application program for generating a paint or other drawing pattern. Both global and local positioning systems can be used, such as a local positioning technology known as Total Station, which uses a laser (robot) atop a tripod to track a retro reflector on a vehicle. The external computer provides a print file having data corresponding to the color and intensity of a drawing pattern on a transportable medium or through a direct connection to the positioning system paint sprayer. The positioning system paint sprayer or the external computer converts the locations of paint in the drawing pattern to geographical mark locations. The positioning system paint sprayer sprays paint when a positioning system-based location of the paint sprayer matches one of the geographical mark locations.

The external computer can be a standard personal computer, having a conventional operating system printer service program and loaded with the application program that is available from some other source and the paint sprayer driver program. A designer uses the application program to generate a drawing having pixels that are an image of the desired geographical drawing pattern. The application program may be a commercially available drawing program, or a commercially available Geographical Information Systems program. The paint sprayer driver program converts data for the drawing pattern generated by the application program and processed by the operating system service program into the print file in a form that can be understood by the positioning system paint sprayer in a similar manner to a printer driver for a desktop printer.

Continuous lines or discrete spots can be painted. The continuous line mode would typically be selected for painting lines on a road, airfield, parking lot or athletic field. The discrete spot mode would typically be selected for painting a logo or alphanumeric characters. The continuous line mode instructs operating system service program to provide the image of the drawing pattern as vector data. The discrete spot mode instructs the operating system service program for providing the image of the drawing pattern as raster data.

The colors inform the operating system service program of the colors that are available for color mapping and/or gray scale conversion and are passed to the positioning system paint sprayer to instruct a person or paint head to operate the paint sprayer as to the colors and quantities for each of the colors that must be loaded. Instructions to the paint spray operator for sheen, viscosity, thinning, and/or specific paint by manufacturer and model number can be included.

A dithering mode instructs the operating system service program to match colors exactly by applying two paint colors, such as yellow and blue to obtain green.

A fixed geographical conversion can use geographical coordinates that are pre-determined in the application program such as a road design program providing geographical data from a survey for the road. A selected geographical conversion enables the designer to use the geographical drawing converter in the external computer to select the geographical coordinates of the drawing pattern. Typically, a designer would select the geographical coordinates of the drawing pattern in the external computer for a specific road, parking lot, or architectural plot where positioning system-based or the equivalent location information was available to the designer. A deferred geographical conversion defers the selection of the geographical coordinates of the drawing pattern to the positioning system paint sprayer on-site. For example, geographical locations for a sports field marking, a logo, or an advertisement that is intended for use in several locations would typically be deferred to on-site selection in the positioning system paint sprayer using the positioning system receiver.

The positioning system paint sprayer can including at least one nozzle and a controller. Preferably, the nozzle is constructed for spraying paint. However, in an alternative, the nozzle may be constructed for depositing chalk, lime, or other marking material. The controller includes a computer data interface, a user interface device, a display, and the positioning system receiver. The positioning system receiver connects to a positioning system antenna. The positioning system antenna receives an airwave positioning system signal including location-determination information from one or more positioning system satellites or positioning system pseudolites and passes the positioning system signal in a conducted form to the positioning system receiver. The positioning system receiver uses the location-determination information in the positioning system signal for determining a positioning system-based location for the positioning system antenna. Data in the form of a print file for the drawing pattern is received from the external computer through the computer data interface. The paint spray operator enters information to the controller through the user interface device and receives information from the display.

The vehicle for marking a roadway is typically a motor vehicle. The vehicle for a field is typically is at least one of a manual push carrier, a golf cart like apparatus, a riding lawn mower type apparatus, an unmanned robot, and an autonomous vehicle.

A jet selector can include data for a color table having data for the position offsets of the respective spray jets in the track direction and the cross track direction as compared to the positioning system antenna. Preferably, the positioning system antenna is fixedly mounted on the controller and the position offsets in the cross track direction include the effect of the current extension of the positioning arms. Alternatively, the positioning system antenna may be mounted on the nozzle, whereby the effect of the current extension of the positioning arms is not required. The operator of the paint sprayer loads the desired colors into the respective spray jets or their reservoirs and then indicates the arrangement of the colors for the respective spray jets through the user interface device for storage in the color table. As a part of the process of detecting the location match, the location comparator uses coding in the jet selector for adjusting either the current positioning system-based location or the geographical mark location data according to the color table for the position offsets in the track direction and the cross track direction.

Other suitable compositions, methods, and dispensing apparatuses are described in U.S. Pat. No. 6,074,693 to Manning, entitled “Global positioning system controlled paint sprayer”; US20180009256 to Traficante, entitled “Three-dimensional graphics made on grass using a chlorophyll-based agent”; U.S. Pat. No. 9,528,228 to Allega, entitled “Vehicle-mounted ground marking system and method”; U.S. Pat. No. 8,935,091 to Davis, WO2016063260 to Marin-Valdez; US20050239675 to Makansi; U.S. Pat. No. 9,732,487 to Schattinger; JPS5952914 to Hekisuto; U.S. Pat. No. 6,329,321 to Okura; U.S. Pat. No. 8,637,432 to Baur; KR101040103 to DPI Holdings; U.S. Pat. No. 9,861,942 to Benjamin Paul; and US20070174980 to Prevost. The entirety of each of these documents are incorporated herein by reference.

This written description uses examples of the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system for applying and removing surface markings to and from a surface, the system comprising:
a vehicle comprising a spray system wherein the spray system comprises at least one of a marking fluid, a marking fluid container, a removal fluid, a removal fluid container, a foam generator, and a manifold;
wherein the manifold is in fluid communication with at least one of the marking fluid container and the removal fluid container, the manifold further comprising a plurality of valves coupled to the manifold such that a valve cavity is defined between each valve and the manifold, each valve cavity configured to be in fluid communication with the marking fluid container and removal fluid container, and wherein each valve includes a poppet between an opened position and a closed position;
a plurality of spray nozzles coupled to the manifold, each spray nozzle being in fluid communication with the manifold, wherein when the poppet is moved to the opened position, marking fluid or removal fluid flows from the valve cavity into the spray nozzle;
wherein each spray nozzle is in fluid communication with the foam generator configured to generate a foaming carrier of mono-dispersed emulsions from two immiscible fluids, wherein one of the two immiscible fluids is the marking fluid, the removal fluid, and combinations thereof; and
a positioning system comprising a controller communicatively coupled to the valves, foam generators, and at least one sensor, wherein the controller is configured to independently control the operation of each valve so as to regulate the flow of marking fluid and removal fluid supplied to each spray nozzle, wherein the flow of marking fluid and removal fluid supplied to each spray nozzle is regulated such that the marking fluid and removal fluid is discharged through the foam generator to generate a desired penetration depth of the surface marking or removal fluid into an area of the surface being marked or cleaned, and wherein the controller is further configured to control displacement of each of the poppets between the opened and closed positions.

2. The system of claim 1, wherein the vehicle is at least one of a manual push carrier, a golf cart like apparatus, a riding lawn mower type apparatus, an unmanned robot, and an autonomous vehicle.

3. The system of claim 1, wherein the marking fluid comprises at least one of dispersants, thickeners, emulsion polymers, acrylic emulsion polymers, styrene acrylics, vinyl acrylics, acetates, crosslinkers, paint, and colorants.

4. The system of claim 1, wherein the surface comprises at least one of a natural turf, an artificial turf, a plant, plant-like matrix, and a solid surface.

5. The system of claim 1, wherein the foaming carrier comprises at least one of a solution of the primary active agent, a compatible surfactant, a mixture of surfactants, enhancing agents, and secondary active agents.

6. The system of claim 5, wherein the primary active agent comprises organic acids, inorganic acids, aldehydes, ketones, simple straight chain mono-functional alcohols, mono-functional ethers, esters, organic bases, alkali metal hydroxides, carbonates and silicates, oxidizing agents and bleaching agents, terpenes, mixtures of a surfactant and a chelating agent, topically applied liquid medications and disinfectants, commercially formulated liquid cleaners, lubricants, quaternary ammonium compounds, and mixtures thereof.

7. The system of claim 5, wherein the primary active agent comprises methyl alcohol, ethyl alcohol, propyl alcohol, butyl alcohol, dimethyl ether, methyl ethyl ether, diethyl ether, methyl acetate, ethyl acetates, propyl acetate, amyl acetate, and mixtures thereof.

8. The system of claim 1, wherein the positioning system comprises a data interface for receiving print data for a drawing pattern, a receiver for determining a location of the nozzles, a geographical drawing converter for using a geographical reference location for converting the print data to geographical mark locations, and a location comparator for detecting a location match when the location matches one of the geographical mark locations and generating a control signal when the location match is detected.

9. The system of claim 1, wherein the at least one sensor comprises a global positioning satellite receiver, a visioning system receiver, a laser receiver, a sonar receiver, and radar receiver.

10. A foaming carrier composition comprising at least one of a solution of a primary active agent, a compatible surfactant, a mixture of surfactants, enhancing agents, and secondary active agents.

11. The foaming carrier composition of claim 10, wherein the primary active agent comprises at least one of dispersants, thickeners, emulsion polymers, acrylic emulsion polymers, styrene acrylics, vinyl acrylics, acetates, crosslinkers, paint, colorants, organic acids, inorganic acids, aldehydes, ketones, simple straight chain mono-functional alcohols, mono-functional ethers, esters, organic bases, alkali metal hydroxides, carbonates and silicates, oxidizing agents and bleaching agents, terpenes, mixtures of a surfactant and a chelating agent, topically applied liquid medications and disinfectants, commercially formulated liquid cleaners, lubricants, quaternary ammonium compounds and mixtures thereof.

12. The foaming carrier of claim 10, wherein the carrier has a foam syneresis value in the range of 1 to 60%, a foam horizontal thickness half-life of at least 2 seconds, and a foam vertical-surface clingability of at least 2 seconds.

13. An aerosol composition, comprising a propellant, water, a water-insoluble polymer, a surfactant, a foam stabilizing agent, and a solvent that solvates said foam stabilizing agent.

14. The aerosol composition of claim 13, wherein the propellant comprises an amount ranging from about 5 to about 40 weight percent of the composition.

15. The aerosol composition of claim 13, wherein the water-insoluble polymer comprises an amount ranging from about 1 to about 25 weight percent of the composition.

16. The aerosol composition of claim 13, wherein the water comprises an amount ranging from about 10 to about 90 weight percent of the composition.

17. The aerosol composition of claim 13, wherein the surfactant comprises an amount ranging from about 0.1 to about 15 weight percent of the composition.
